(19) United States
(12) Patent Application Publication
(10) Pub. No.: US 2009/0202882 A1
(43) Pub. Date: Aug. 13, 2009

(54) POLYMER ELECTROLYTE FUEL CELL AND FUEL CELL SYSTEM INCLUDING THE SAME

(75) Inventors: Shinsuke Takeguchi, Osaka (JP); Yoichiro Tsuji, Osaka (JP)

Correspondence Address: MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD., Osaka (JP)

(21) Appl. No.: 12/293,338

(22) PCT Filed: Mar. 28, 2007
(86) PCT No.: PCT/JP2007/056569

§ 371 Date: Sep. 17, 2008

(30) Foreign Application Priority Data
Apr. 4, 2006 (JP) 2006-102803

(51) Int. Cl. H01M 8/10; H01M 4/92

(52) U.S. Cl. 429/30; 429/40

(57) ABSTRACT

A polymer electrolyte fuel cell includes a cell stack (51) formed by stacking cells (11), each of which includes: an MEA (5) having a polymer electrolyte membrane (1), and an anode (4a) and a cathode (4b) sandwiching the polymer electrolyte membrane (1); and an anode separator (6a) and a cathode separator (6b) disposed to sandwich the MEA (5), an anode gas internal supplying channel is formed to supply a fuel gas and air to the anode (4a), and a CO removing catalyst layer (61) containing a CO removing catalyst is formed in the anode gas internal supplying channel.

### TECHNICAL FIELD

The present invention relates to a polymer electrolyte fuel cell and a fuel cell system including the same, and particularly to the configuration of the polymer electrolyte fuel cell.

### BACKGROUND ART

A polymer electrolyte fuel cell (hereinafter referred to as “PEFC”) is a device which causes a hydrogen-rich fuel gas obtained by reforming a material gas, such as a city gas, and an oxidizing gas, such as air, containing oxygen, to electrochemically react with each other to generate electric power and heat. A unit cell (cell) of the PEFC includes: an MEA (Membrane-Electrode Assembly; electrolyte membrane-electrode assembly) constituted by a polymer electrolyte membrane and a pair of gas diffusion electrodes (an anode and a cathode); gaskets; and electrically-conductive separators. Each gas diffusion electrode includes a catalyst layer and a gas diffusion layer. Each separator is provided on its surface contacting the gas diffusion electrode, with a groove-like gas channel through which the fuel gas or the oxidizing gas flows.

An infrastructure configured to supply a fuel gas (hydrogen gas) as fuel during the electric power generation of the PEFC is not developed as a common infrastructure. Therefore, in the case of mounting the PEFC on a domestic fuel cell cogeneration system or a fuel cell vehicle and operating it, a hydrogen generator, which carries out a steam-reforming reaction of a raw material obtained from an existing infrastructure, such as a natural gas, a propane gas, methanol or gasoline, to generate a hydrogen gas, is typically disposed with the fuel cell.

The fuel gas generated by the hydrogen generator contains several ppm to several tens of ppm of carbon monoxide (CO) derived from the raw material. The CO poisons an anode catalyst of the PEFC, and this increases polarization of the anode. Thus, the cell performance deteriorates.

To solve such problem, a fuel cell is known, in which by causing a fuel gas diffusion layer of the anode to support a CO selective oxidation catalyst, the CO is removed before reaching an anode catalyst, thereby avoid the poisoning of the anode catalyst (see Patent Document 1 for example).

Patent Document 1: Japanese Laid-Open Patent Application Publication No. Hei 9-129243

### DISCLOSURE OF THE INVENTION

### Problems to be Solved by the Invention

However, in the fuel cell described in Patent Document 1, since the CO selective oxidation catalyst is disposed only in the fuel gas diffusion layer, the capacity of the fuel gas diffusion layer to support the CO selective oxidation catalyst is limited. Therefore, when the CO concentration increases at the time of transition, such as a start-up time or a load changing time, the CO cannot be completely removed, thereby deteriorating the cell performance. On this account, it is necessary to secure a larger surface area of a CO removing catalyst.

Recently, to prevent the cell performance from deteriorating due to the CO poisoning, a catalyst of an alloy of Pt and Ru has been used as the anode catalyst. However, due to a potential change at the time of start-up and stop of the PEFC, Ru in the catalyst is dissolved, thereby deteriorating the resistance to the CO. In the fuel cell described in Patent Document 1, the catalyst is supported in the fuel gas diffusion layer disposed next to the catalyst layer. Therefore, even if the Pt/Ru alloy is used as the catalyst, it is affected by the potential change, and thereby the Ru is dissolved. Thus, the above problem of the deterioration of the resistance to the CO has not yet been solved.

The present invention was made to solve the above problem, and an object of the present invention is to provide a polymer electrolyte fuel cell capable of surely remove the CO contained in the fuel gas, and a fuel cell system including the polymer electrolyte fuel cell.

### Means for Solving the Problems

To solve such problem, a polymer electrolyte fuel cell of the present invention includes: cells, each of which includes: an MEA having a polymer electrolyte membrane, and an anode and a cathode sandwiching the polymer electrolyte membrane; and an anode separator and a cathode separator disposed to sandwich the MEA; and a cell stack formed by stacking the cells, wherein an anode gas internal supplying channel is formed to supply a fuel gas and air to the anode inside the cell stack; and a CO removing catalyst layer containing a CO removing catalyst is formed in the anode gas internal supplying channel.

With this, the CO contained in the fuel gas can be removed upstream of the anode constituting the PEFC. Thus, it is possible to surely avoid the deterioration of the cell performance. Moreover, the CO removing catalyst layer is disposed inside the cell stack, thereby saving spaces. Further, the catalytic activity can be obtained by the inner temperature of the cell stack without heating the CO removing catalyst, thereby saving energy.

The CO removing catalyst layer may further contain a carrier, which supports the CO removing catalyst.

The anode gas internal supplying channel may be a groove-like anode gas channel formed on an inner surface of the anode separator.

With this, the capacity of each cell to support the CO removing catalyst can be adequately secured. Thus, the CO contained in the fuel gas can be surely removed upstream of the anode constituting the PEFC.

The anode separator may be provided at a starting end of the anode gas channel thereof with an anode gas supplying manifold hole, which penetrates through the anode separator in a stack direction and is used to supply the fuel gas and the air; the anode gas supplying manifold holes may be communicated with each other so as to form an anode gas supplying manifold, by stacking the cells; and the anode gas internal supplying channel may include the anode gas supplying manifold.

With this, the inner space of the cell stack can be effectively utilized by disposing the CO removing catalyst layer in the anode gas supplying manifold formed in the cell stack. Moreover, the capacity to support the CO removing catalyst can be adequately secured. Thus, the CO contained in the fuel gas can be surely removed upstream of the anode constituting the PEFC.

The anode gas internal supplying channel may include the anode gas channel and the anode gas supplying manifold.

A CO remover may be disposed in the anode gas supplying manifold.

With this, the concentration of the CO in the fuel gas having been supplied to the PEFC can be reduced before the fuel gas reaches respective cells. Thus, it is possible to obtain a larger effect than a case where the CO removing catalyst is formed only in the anode gas internal supplying channel.

The CO remover may contain the CO removing catalyst, a carrier supporting the CO removing catalyst, and a container having non-electrical conductivity and gas permeability; and the carrier may be stored in the container.

The carrier may be stored in the container such that an inside of the container has gas permeability.

The carrier may be formed of a porous body.

The carrier may be in a pellet form.

The CO removing catalyst may contain as a constituent element at least one metallic element selected from a metal group consisting of Pt, Ru, Pd, Au, and Rh.

The CO removing catalyst layer may be formed such that the carrier supports simple substances of at least two metals and/or metal oxides selected from the metal group forming the CO removing catalyst and a metal oxide group consisting of oxides of metals of the metal group, and the simple substances contact each other.

A fuel cell system of the present invention includes: the polymer electrolyte fuel cell; a fuel gas supplying device which supplies the fuel gas to the anode; an air supplying device which supplies the air to the anode gas internal supplying channel; and an oxidizing gas supplying device which supplies the oxidizing gas to the cathode.

With this, the CO contained in the fuel gas can be removed upstream of the anode constituting the polymer electrolyte fuel cell. Thus, it is possible to surely avoid the deterioration of the cell performance.

### EFFECTS OF THE INVENTION

In accordance with the polymer electrolyte fuel cell of the present invention and the fuel cell system including the same, the CO contained in the fuel gas can be removed before reaching the anode catalyst. Therefore, it is possible to surely avoid the deterioration of the cell performance due to the CO poisoning of the anode catalyst.

### BRIEF DESCRIPTION OF THE DRAWINGS

FIG. 1 is a block diagram schematically showing the configuration of a fuel cell system according to Embodiment 1 of the present invention.

FIG. 2 is a schematic diagram showing a polymer electrolyte fuel cell of the fuel cell system of FIG. 1.

FIG. 3 is a cross-sectional view schematically showing the configuration of a cell constituting the polymer electrolyte fuel cell shown in FIG. 2.

FIG. 4 is a schematic diagram showing the configuration of an inner surface of an anode separator of the cell shown in FIG. 3.

FIG. 5 are schematic diagrams showing a part of the configuration of the polymer electrolyte fuel cell in the fuel cell system according to Embodiment 2 of the present invention.

FIG. 6 is a schematic diagram showing a modification example of a CO remover in the polymer electrolyte fuel cell shown in FIG. 5.

FIG. 7 is a schematic diagram showing a part of the configuration of the polymer electrolyte fuel cell in the fuel cell system according to Embodiment 2 of the present invention.

### EXPLANATION OF REFERENCE NUMBERS

1 polymer electrolyte membrane
2a anode catalyst layer
2b cathode catalyst layer
3a anode gas diffusion layer 3b cathode gas diffusion layer
4a anode
4b cathode
5 MEA
6a anode separator
6b cathode separator
7 anode gas channel
7a horizontal portion
7b vertical portion
8 cathode gas channel
9a heat transfer medium channel 9b heat transfer medium channel
10 gasket
11 cell
12E anode gas discharging manifold hole
12I anode gas supplying manifold hole
13E cathode gas discharging manifold hole
13I cathode gas supplying manifold hole
14E heat transfer medium discharging manifold hole
14I heat transfer medium supplying manifold hole
22E anode gas discharging manifold
22I anode gas supplying manifold
23E cathode gas discharging manifold
23I cathode gas supplying manifold
24E heat transfer medium discharging manifold
24I heat transfer medium supplying manifold
32E anode gas discharging pipe
32I anode gas supplying pipe
33E cathode gas discharging pipe cathode gas supplying pipe
34E heat transfer medium discharging pipe
34I heat transfer medium supplying pipe
41a first end plate
41b second end plate
50 cell stack body
51 cell stack
51a cell stack
60 contact portion
61 CO removing catalyst layer
62 container
63 carrier
63a carrier
64 CO remover
64a CO remover
100 polymer electrolyte fuel cell
100a polymer electrolyte fuel cell
101 fuel gas supplying device
102 CO oxidation air supplying device
103 oxidizing gas supplying device
104 heat transfer medium supplying device
105 fuel gas supplying passage
106 air supplying passage
107 fuel gas discharging passage
108 oxidizing gas supplying passage
109 oxidizing gas discharging passage
110 heat transfer medium supplying passage
111 heat transfer medium discharging passage

### BEST MODE FOR CARRYING OUT THE INVENTION

Hereinafter, preferred embodiments of the present invention will be explained in reference to the drawings.

### Embodiment 1

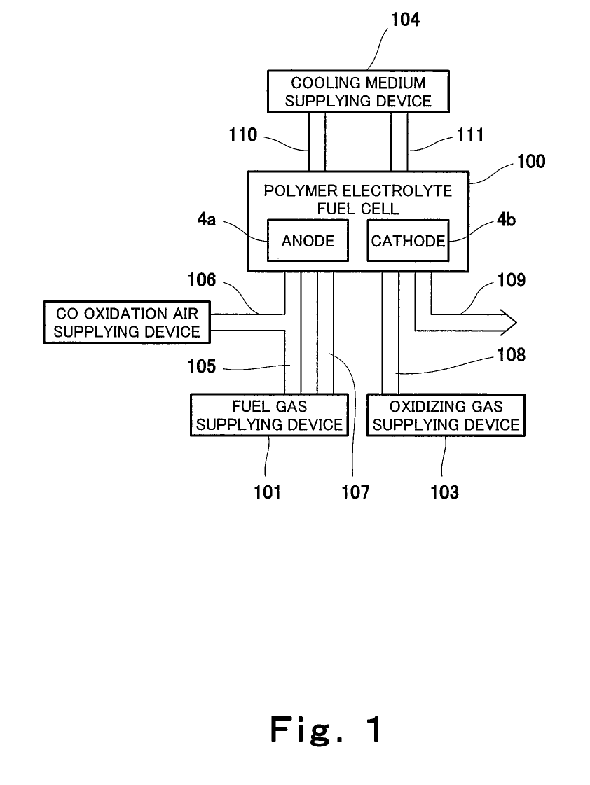

FIG. 1 is a block diagram schematically showing the configuration of a fuel cell system according to Embodiment 1 of the present invention.

First, the configuration of the fuel cell system according to Embodiment 1 will be explained.

As shown in FIG. 1, the fuel cell system according to Embodiment 1 includes a polymer electrolyte fuel cell (hereinafter referred to as “PEFC”) 100, a fuel gas supplying device 101, a fuel gas supplying passage 105, a CO oxidation air supplying device 102, an air supplying passage 106, a fuel gas discharging passage 107, an oxidizing gas supplying device 103, an oxidizing gas supplying passage 108, an oxidizing gas discharging passage 109, a heat transfer medium supplying device 104, a heat transfer medium supplying passage 110, and a heat transfer medium discharging passage 111.

The PEFC 100 is connected to the fuel gas supplying passage 105, and the fuel gas supplying passage 105 is connected to the fuel gas supplying device 101. The fuel gas supplying device 101 supplies the fuel gas through the fuel gas supplying passage 105 to an anode 4a of the PEFC 100. Herein, the fuel gas supplying device 101 includes: a plunger pump (not shown) which delivers to a fuel processor (not shown) a natural gas (material gas) having been supplied from a natural gas supplying infrastructure; a flow rate adjuster (not shown) capable of adjusting the amount of the natural gas delivered; and the fuel processor which reforms the delivered natural gas into a hydrogen-rich fuel gas. The fuel processor carries out a reforming reaction between the natural gas and steam to generate a reformed gas. Then, the fuel processor decreases CO contained in this reformed gas up to about 1 ppm to generate the fuel gas. The PEFC 100 is also connected to the fuel gas discharging passage 107, and the fuel gas discharging passage 107 is connected to the fuel processor of the fuel gas supplying device 101.

The fuel gas supplying passage 105 is connected to the air supplying passage 106, and the air supplying passage 106 is connected to the CO oxidation air supplying device 102. The CO oxidation air supplying device 102 supplies air for oxidizing the CO contained in the fuel gas, through the air supplying passage 106 and the fuel gas supplying passage 105 to the anode 4a of the PEFC 100. Herein, the CO oxidation air supplying device 102 is constituted by a blower (not shown) whose inlet port is open in the atmosphere. The blower can adjust a supply amount of air by changing a rotating speed. The CO oxidation air supplying device 102 may be configured to use a fan or the like, such as a sirocco fan.

The PEFC 100 is connected to the oxidizing gas supplying passage 108, and the oxidizing gas supplying passage 108 is connected to the oxidizing gas supplying device 103. The oxidizing gas supplying device 103 supplies an oxidizing gas through the oxidizing gas supplying passage 108 to a cathode 4b of the PEFC 100. Herein, the oxidizing gas supplying device 103 is constituted by a blower (not shown) whose inlet port is open in the atmosphere. The oxidizing gas supplying device 103 may be configured to use a fan or the like, such as a sirocco fan.

Moreover, the PEFC 100 is connected to the oxidizing gas discharging passage 109 to discharge an unreacted oxidizing gas to an outside of the system.

Further, the PEFC 100 is connected to the heat transfer medium supplying passage 110 and the heat transfer medium discharging passage 111, and these passages are connected to the heat transfer medium supplying device 104. To maintain the cell at an appropriate temperature, the heat transfer medium supplying device 104 is configured to supply a heat transfer medium to the PEFC 100 and cool down or heat the discharged heat transfer medium. Herein, water is used as the heat transfer medium.

The PEFC 100 causes the fuel gas, which contains hydrogen and is supplied from the fuel gas supplying device 101, and the oxidizing gas, which contains oxygen and is supplied from the oxidizing gas supplying device 103, to electrochemically react with each other to generate water and electricity. At this time, the PEFC 100 supplies an unreacted fuel gas as an off gas through the fuel gas discharging passage 107 to the fuel processor of the fuel gas supplying device 101.

Next, the configuration of the PEFC 100 of the fuel cell system according to Embodiment 1 will be explained.

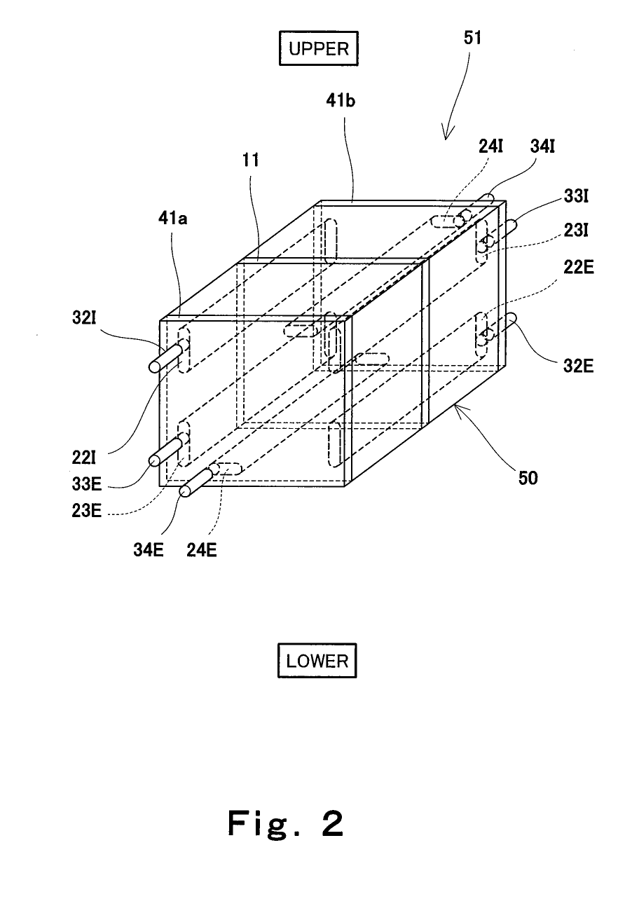

FIG. 2 is a schematic diagram showing the PEFC 100 of the fuel cell system of FIG. 1. Note that a vertical direction of the PEFC 100 corresponds to a vertical direction of FIG. 2.

As shown in FIG. 2, the PEFC 100 includes a cell stack 51. The cell stack 51 includes: a cell stack body 50 formed by stacking plate-shaped cells 11 in its thickness direction; first and second end plates 41a and 41b disposed on both ends, respectively, of the cell stack body 50; and fastening members (not shown) configured to fasten the cell stack body 50 and the first and second end plates 41a and 41b in a stack direction of the cells 11. Although not shown, a current collector and an insulating plate are disposed on each of the first and second end plates 41a and 41b. The plate-shaped cell 11 extends in parallel with a vertical surface, and the stack direction of the cell 11 is a horizontal direction.

An anode gas supplying manifold 22I is formed on an upper portion of one side portion (hereinafter referred to as “first side portion”) of the cell stack body 50 so as to penetrate through the cell stack body 50 in the stack direction. One end of the anode gas supplying manifold 22I is communicated with a through hole formed on the first end plate 41a, and this through hole is connected to an anode gas supplying pipe 32I. The other end of the anode gas supplying manifold 22I is closed by the second end plate 41b. The anode gas supplying pipe 32I is connected to the fuel gas supplying passage 105 (see FIG. 1). Moreover, an anode gas discharging manifold 22E is formed on a lower portion of the other side portion (hereinafter referred to as “second side portion”) of the cell stack body 50 so as to penetrate through the cell stack body 50 in the stack direction. One end of the anode gas discharging manifold 22E is communicated with a through hole formed on the second end plate 41b, and this through hole is connected to an anode gas discharging pipe 32E. The other end of the anode gas discharging manifold 22E is closed by the first end plate 41a. The anode gas discharging pipe 32E is connected to the fuel gas discharging passage 107 (see FIG. 1). Herein, the cross section of the anode gas supplying manifold 22I is an elongate hole shape (shape formed by replacing each of two opposing sides of a rectangle with an arc of a semicircle) which is long in the vertical direction.

A cathode gas discharging manifold 23E is formed on a lower portion of the first side portion of the cell stack body 50 so as to penetrate through the cell stack body 50 in the stack direction. One end of the cathode gas discharging manifold 23E is communicated with a through hole formed on the first end plate 41a, and this through hole is connected to a cathode gas discharging pipe 33E. The other end of the cathode gas discharging manifold 23E is closed by the second end plate 41b. The cathode gas discharging pipe 33E is connected to the oxidizing gas discharging passage 109 (see FIG. 1). Moreover, a cathode gas supplying manifold 23I is formed on an upper portion of the second side portion of the cell stack body 50 so as to penetrate through the cell stack body 50 in the stack direction. One end of the cathode gas supplying manifold 23I is communicated with a through hole formed on the second end plate 41b, and this through hole is connected to a cathode gas supplying pipe 33I. The other end of the cathode gas supplying manifold 23I is closed by the first end plate 41a. The cathode gas supplying pipe 33I is connected to the oxidizing gas supplying passage 108 (see FIG. 1).

A heat transfer medium discharging manifold 24E is formed on an inner side of a portion below the cathode gas discharging manifold 23E on the first side portion of the cell stack body 50 so as to penetrate through the cell stack body 50 in the stack direction. One end of the heat transfer medium discharging manifold 24E is communicated with a through hole formed on the first end plate 41a, and this through hole is connected to a heat transfer medium discharging pipe 34E. The other end of the heat transfer medium discharging manifold 24E is closed by the second end plate 41b. The heat transfer medium discharging pipe 34E is connected to the heat transfer medium discharging passage 111 (see FIG. 1). Moreover, a heat transfer medium supplying manifold 241 is formed on an inner side of a portion above the cathode gas supplying manifold 23I on the second side portion of the cell stack body 50 so as to penetrate through the cell stack body 50 in the stack direction. One end of the heat transfer medium supplying manifold 24I is communicated with a through hole formed on the second end plate 41b, and this through hole is connected to a heat transfer medium supplying pipe 34I. The other end of the heat transfer medium supplying manifold 24I is closed by the first end plate 41a. The heat transfer medium supplying pipe 341 is connected to the heat transfer medium supplying passage 110 (see FIG. 1).

Next, the configuration of the cell 11 of the PEFC 100 according to Embodiment 1 will be explained.

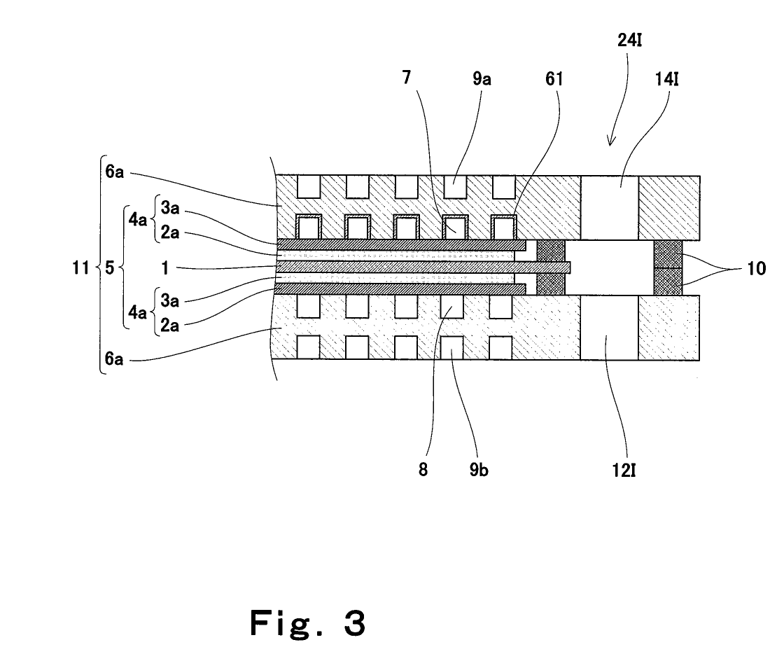

FIG. 3 is a cross-sectional view schematically showing the configuration of the cell 11 constituting the PEFC 100 shown in FIG. 2. In FIG. 3, a part of the cell 11 is omitted.

As shown in FIG. 3, the cell 11 includes an MEA (Membrane-Electrode Assembly; electrolyte membrane-electrode assembly) 5, gaskets 10, an anode separator 6a, and a cathode separator 6b.

The MEA 5 includes: a polymer electrolyte membrane 1 which selectively transports hydrogen ions; the anode 4a; and the cathode 4b. The anode 4a and the cathode 4b are disposed on both surfaces, respectively, of the polymer electrolyte membrane 1 so as to be located inwardly of a peripheral portion of the polymer electrolyte membrane 1. The anode 4a is disposed on one main surface of the polymer electrolyte membrane 1, and includes: an anode catalyst layer 2a whose major component is carbon powder supporting a platinum-based metal catalyst; and an anode gas diffusion layer 3a which is disposed on the anode catalyst layer 2a and has gas permeability and electrical conductivity. Similarly, the cathode 4b is formed on the other main surface of the polymer electrolyte membrane 1, and includes: a cathode catalyst layer 2b whose major component is carbon powder supporting a platinum-based metal catalyst; and a cathode gas diffusion layer 3b which is disposed on the cathode catalyst layer 2b and has gas permeability and electrical conductivity. One preferable example of the polymer electrolyte membrane is a membrane which selectively allows the hydrogen ion to pass therethrough, that is, which has an ion exchange function. One preferable example of such membrane is a polymer electrolyte membrane having such a structure that —CF₂— is a main chain skeleton thereof and a sulfonic acid group is introduced to an end of a side chain thereof. One preferable example of the membrane having such structure is a perfluoro carbon sulfonic acid membrane.

A pair of gaskets 10 made of fluorocarbon rubber are disposed around the anode 4a and the cathode 4b, respectively, so as to sandwich the polymer electrolyte membrane 1. With this, the fuel gas, air, and the oxidizing gas are prevented from leaking outside the cell, and these gases are prevented from being mixed with each other in the cell 11. Manifold holes, such as an anode gas supplying manifold hole 12I, which are through holes extending in the thickness direction, are formed on a peripheral portion of the gasket 10.

The electrically-conductive anode separator 6a and the electrically-conductive cathode separator 6b are disposed so as to sandwich the MEA 5 and the gaskets 10. Used as each of the separators 6a and 6b is a resin-impregnated graphite plate obtained by impregnating a graphite plate with phenol resin and then hardening the graphite plate. Alternatively, a separator made of a metallic material, such as SUS, may be used as each of the separators 6a and 6b. The MEA 5 is mechanically fixed by the anode separator 6a and the cathode separator 6b, and adjacent MEAs are electrically connected to one another in series by the anode separator 6a and the cathode separator 6b.

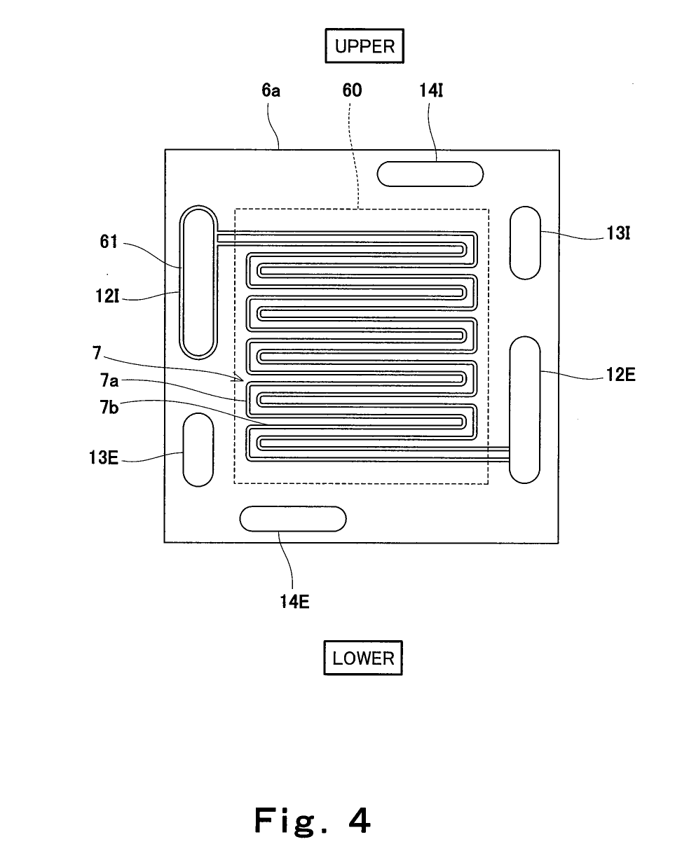

A groove-like anode gas channel 7 through which the fuel gas and the air (anode gas) flow is formed in a serpentine shape on an inner surface (surface contacting the MEA 5) of the anode separator 6a. Moreover, a groove-like heat transfer medium channel 9a through which a heat transfer medium flows is formed in a serpentine shape on an outer surface of the anode separator 6a. Further, manifold holes (see FIG. 4), such as the anode gas supplying manifold hole 12I, which are through holes extending in the thickness direction, are formed on a peripheral portion of the anode separator 6a.

A groove-like cathode gas channel 8 through which the oxidizing gas (cathode gas) flows is formed in a serpentine shape on an inner surface of the cathode separator 6b, and a groove-like heat transfer medium channel 9b through which the heat transfer medium flows is formed in a serpentine shape on an outer surface of the cathode separator 6b. As with the anode separator 6a, manifold holes, such as the anode gas supplying manifold hole 12I, which are through holes extending in the thickness direction, are formed on a peripheral portion of the cathode separator 6b.

The cells 11 formed as above are stacked in the thickness direction to form the cell stack body 50. The manifold holes, such as the anode gas supplying manifold hole 121, formed on the anode separator 6a, the cathode separator 6b, and the gaskets 10 are connected to each other in the thickness direction by stacking the cells 11, thereby forming manifolds, such as the anode gas supplying manifold 22I. The anode gas supplying manifold 22I and the anode gas channel 7 constitutes an anode gas internal supplying channel.

Next, the configuration of the inner surface of the anode separator 6a will be explained in detail in reference to FIGS. 3 and 4.

FIG. 4 is a schematic diagram showing the configuration of the inner surface of the anode separator 6a of the cell 11 shown in FIG. 3. Note that a vertical direction of the anode separator 6a corresponds to the vertical direction of FIG. 4.

As shown in FIG. 4, the anode separator 6a includes the anode gas supplying manifold hole 12I, an anode gas discharging manifold hole 12E, a cathode gas supplying manifold hole 131, a cathode gas discharging manifold hole 13E, a heat transfer medium supplying manifold hole 14I, and a heat transfer medium discharging manifold hole 14E. The anode separator 6a includes the groove-like anode gas channel 7 which is formed in a serpentine shape in an entire contact portion 60, contacting the MEA 5, so as to connect the anode gas supplying manifold hole 12I and the anode gas discharging manifold hole 12E.

In FIG. 4, the anode gas supplying manifold hole 12I is formed on an upper portion of one side portion (side portion located on the left side of FIG. 4; hereinafter referred to as “first side portion”) of the anode separator 6a, and the anode gas discharging manifold hole 12E is formed on a lower portion of the other side portion (side portion on the right side of FIG. 4; hereinafter referred to as “second side portion”) of the anode separator 6a. The cathode gas supplying manifold hole 13I is formed on an upper portion of the second side portion of the anode separator 6a, and the cathode gas discharging manifold hole 13E is formed on a lower portion of the first side portion of the anode separator 6a. The heat transfer medium supplying manifold hole 14I is formed on an inner side of a portion above the cathode gas supplying manifold hole 13I, and the heat transfer medium discharging manifold hole 14E is formed on an inner side of a portion below the cathode gas discharging manifold hole 13E.

In the present embodiment, the anode gas channel 7 includes two channels, and each channel substantially includes horizontal portions 7a extending in the horizontal direction and vertical portions 7b extending in the vertical direction. To be specific, each channel of the anode gas channel 7 extends from an upper portion of the anode gas supplying manifold hole 12I to the second side portion of the anode separator 6a in the horizontal direction, extends downward therefrom by a certain distance, extends to the first side portion of the anode separator 6a therefrom, and extends downwardly therefrom by a certain distance. Then, this pattern is repeated four more times therefrom, and the channel further extends therefrom in the horizontal direction to reach a lower portion of the anode gas discharging manifold hole 12E. Such horizontally extending portions form the horizontal portions 7a, and such downwardly extending portions form the vertical portion 7b. Herein, the anode gas channel 7 includes two channels, but is not limited to this, and can be designed arbitrarily within the bounds of not undermining the effects of the present invention. Similarly, the horizontal portion 7a and the vertical portion 7b can be designed as desired. Moreover, the anode gas channel 7 is not limited to be in a serpentine shape, and may be configured such that a plurality of sub channels are formed between one main channel and the other main channel of the channel or that a plurality of channels extend in parallel with one another.

The heat transfer medium channel 9a formed on the outer surface of the anode separator 6a, the cathode gas channel 8 formed on the inner surface of the cathode separator 6b, and the heat transfer medium channel 9b formed on the outer surface of the cathode separator 6b are configured in the same manner as the anode gas channel 7.

As shown in FIGS. 3 and 4, a CO removing catalyst layer 61 is formed on an inner wall of the anode gas channel 7 formed as above and on an inner wall forming the anode gas supplying manifold hole 12I. The CO removing catalyst layer 61 includes a CO removing catalyst and a carrier supporting the CO removing catalyst. In the present embodiment, an alloy of Pt and Ru is used as the CO removing catalyst, and carbon powder is used as the carrier. To adequately obtain the effects of the present invention, it is preferable that the thickness of the CO removing catalyst layer 61 be 10 μm or more. To cause the anode gas to adequately flow through the anode gas channel, it is preferable that the thickness of the CO removing catalyst layer 61 be 20 μm or less. With this, the CO and oxygen contained in the anode gas are caused to reach with each other by catalysis of the CO removing catalyst, thereby generating carbon dioxide and removing the CO. The inside of the PEFC (cell stack) is maintained at a predetermined temperature by the heat transfer medium. Therefore, by disposing the CO removing catalyst inside the cell stack, it becomes unnecessary to heat the CO removing catalyst up to an activation temperature of the catalyst, thereby saving energy.

Herein, the alloy of Pt and Ru is used as the CO removing catalyst. However, the CO removing catalyst is not limited to this, and may be a catalyst containing as a constituent element at least one metallic element selected from the group consisting of Pt, Ru, Pd, Au, and Rh. For example, the CO removing catalyst may be formed such that the state of the constituent element thereof is only a metallic state. In this case, examples of the CO removing catalyst are a simple substance made of only one of the above metallic elements, two or more simple substances made of the above metallic elements, and an alloy of two or more of the above metallic elements. Moreover, the CO removing catalyst may be made of a metallic oxide containing as a constituent element at least one metallic element in the above group (group of the metallic elements). In this case, examples of the CO removing catalyst are a metallic oxide made of only one of the above metallic elements, and an oxide of an alloy of two or more of the above metallic elements. Further, the CO removing catalyst may be formed by arbitrarily combining a metallic-state matter and a metallic oxide, and the CO removing catalyst may be such a catalyst that a part of a surface thereof becomes in an ion (metallic ion for example) state during reactions.

Herein, the CO removing catalyst layer 61 includes the CO removing catalyst and the carrier supporting the CO removing catalyst, but is not limited to this, and may include only the CO removing catalyst. Moreover, the CO removing catalyst layer 61 is formed on both the inner wall of the anode gas channel 7 and the inner wall forming the anode gas supplying manifold hole 12I, but is not limited to this, and may be formed on one of the inner wall of the anode gas channel 7 and the inner wall forming the anode gas supplying manifold hole 12I.

Next, the operation of the fuel cell system according to Embodiment 1 will be explained in reference to FIGS. 1 to 4.

First, the fuel gas is supplied from the fuel gas supplying device 101 through the fuel gas supplying passage 105 to the PEFC 100. At this time, the air is supplied together with the fuel gas from the CO oxidation air supplying device 102 through the air supplying passage 106 and the fuel gas supplying passage 105 to the PEFC 100. Moreover, the oxidizing gas is supplied from the oxidizing gas supplying device 103 through the oxidizing gas supplying passage 108 to the PEFC 100. Further, the heat transfer medium is supplied from the heat transfer medium supplying device 104 through the heat transfer medium supplying passage 110 to the PEFC 100.

In the PEFC 100, the fuel gas having been supplied from the fuel gas supplying device 101 and the air are supplied through the anode gas supplying pipe 32I to the anode gas supplying manifold 22I, and supplied from the anode gas supplying manifold 22I to the anode gas channel 7 of each cell. At this time, the fuel gas having been supplied from the fuel gas supplying device 101 contains several tens of ppm to several ppm (1 ppm for example) of the CO. However, the CO contained in the anode gas and the supplied air react with each other by the CO removing catalyst of the CO removing catalyst layer 61 formed on the anode gas supplying manifold 22I and the anode gas channel 7, thereby removing the CO. Thus, the CO contained in the fuel gas supplied to the anode 4a can be reduced. With this, the CO contained in the fuel gas can be removed before the CO reaches the anode catalyst 2a. Therefore, it is possible to surely avoid the deterioration of the cell performance due to the CO poisoning of the anode catalyst 2a.

Moreover, in the PEFC 100, the oxidizing gas having been supplied from the oxidizing gas supplying device 103 is supplied through the cathode gas supplying pipe 331 to the cathode gas supplying manifold 23I, and supplied from the cathode gas supplying manifold 23I to the cathode gas channel 8 of each cell.

The fuel gas having been supplied to the anode gas channel 7 flows through the anode gas diffusion layer 3a and is supplied to the anode catalyst layer 2a. The oxidizing gas having been supplied to the cathode gas channel 8 flows through the cathode gas diffusion layer 3b and is supplied to the cathode catalyst layer 2b. These gases electrochemically react with each other to generate electricity. The unused fuel gas is discharged through the anode gas discharging manifold 22E and the anode gas discharging pipe 32E to the fuel gas discharging passage 107. Then, the unused fuel gas is supplied as the off gas to the fuel processor of the fuel gas supplying device. Moreover, the unused oxidizing gas is discharged through the cathode gas discharging manifold 23E and the cathode gas discharging pipe 33E to the oxidizing gas discharging passage 109, and discharged to an outside of the system.

Further, in the PEFC 100, the heat transfer medium having been supplied from the heat transfer medium supplying device 104 is supplied through the heat transfer medium supplying pipe 341 to the heat transfer medium supplying manifold 241, and is supplied from the heat transfer medium supplying manifold 241 to the heat transfer medium channels 9a and 9b of each cell. The heat transfer medium having been supplied to the heat transfer medium channels 9a and 9b is discharged through the heat transfer medium discharging manifold 24E and the heat transfer medium discharging pipe 34E to the heat transfer medium discharging passage 111, and is supplied to the heat transfer medium supplying device 104. With this, the inside of the PEFC 100 is maintained at an appropriate temperature.

With this configuration, in the fuel cell system according to Embodiment 1, by forming the CO removing catalyst layer 61 on the anode gas internal supplying channel of the PEFC 100, the CO contained in the fuel gas can be removed before the CO reaches the anode catalyst 2a, and thereby it is possible to surely avoid the deterioration of the cell performance due to the CO poisoning of the anode catalyst 2a.

### Embodiment 2

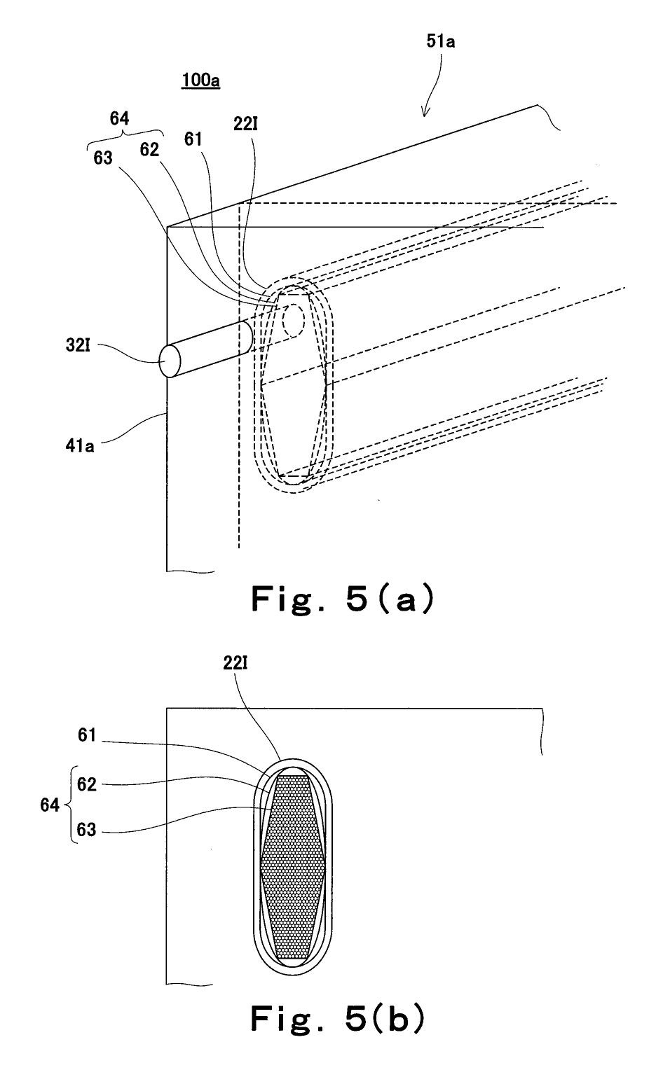

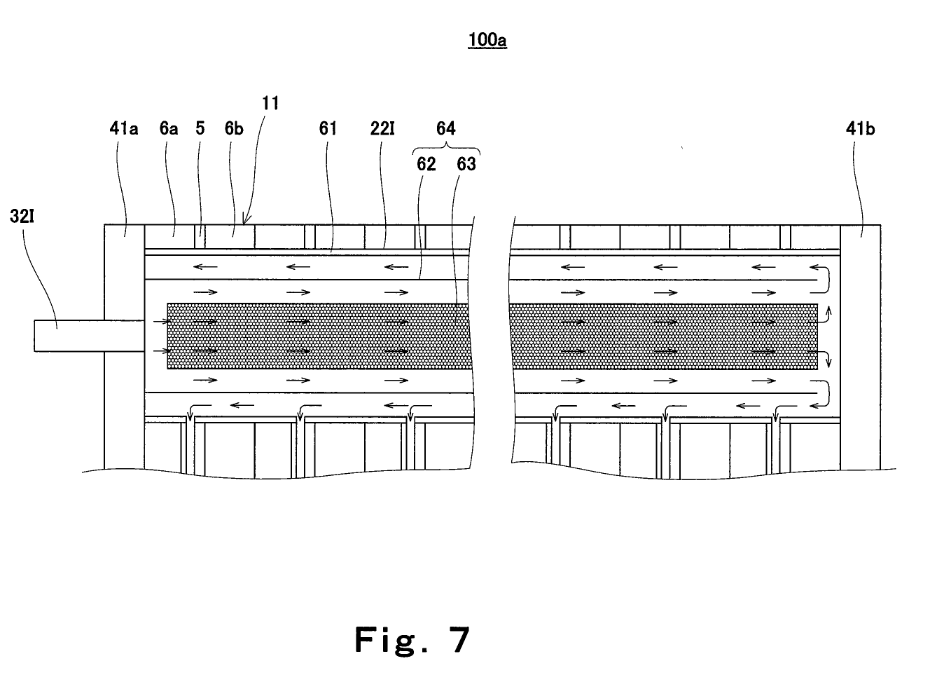

FIG. 5(a) is a schematic diagram showing a part of the configuration of a PEFC 100a of the fuel cell system according to Embodiment 2 of the present invention. FIGS. 5(b) and 7 are schematic diagrams showing a part of the cross section of the PEFC 100a shown in FIG. 5(a).

As shown in FIGS. 5(a), 5(b) and 7, in the PEFC 100a of the fuel cell system according to Embodiment 2, a CO remover 64 is fittingly inserted in the anode gas supplying manifold 22I. The CO remover 64 includes a tubular container 62 and a columnar carrier 63 which is fittingly inserted in the container 62 and supports the CO removing catalyst. The container 62 is disposed such that one side surface (end portion) thereof contacts a main surface of the first end plate 41a (to be specific, the current collector, not shown), and a predetermined gap is formed between the other side surface (end portion) thereof and a main surface of the second end plate 41b (to be specific, the current collector, not shown) (the anode gas flows through this gap).

The container 62 includes on its peripheral wall a large number of small-diameter through holes, and has no electrical conductivity. Examples of such material are ceramic and alumina. With this, the potential difference is maintained without short-circuiting between the stacked cells. The container 62 may include on its peripheral wall through holes through which the anode gas flows.

To increase an area for supporting the CO removing catalyst, it is preferable that the carrier 63 have projections and depressions on its outer surface. Moreover, to allow the fuel gas to smoothly flow, it is more preferable that the carrier 63 be a porous body having extremely high porosity. Examples of such material are ceramic and alumina. Further, to increase the area for supporting the CO removing catalyst, it is preferable that the CO removing catalyst be supported by an inner surface of fine holes of the porous body. Moreover, the carrier 63 is formed in a honeycomb shape. Herein, the cross section of the container 62 is an oval, but is not limited to this, and may be a polygon or the like as long as the container 62 is fittingly inserted in the anode gas supplying manifold 22I. Moreover, the cross section of the carrier 63 is a hexagon, but is not limited to this, and may be a circle or the like as long as the carrier 63 is stored in an internal space of the container 62. Further, to prevent the carrier 63 from coming off from the container 62, both side surfaces (surfaces contacting first and second end plates 41a and 41b (to be specific, the current collectors, not shown), respectively) of the container 62 may be closed by lid members having gas permeability.

In the above PEFC 100a of the fuel cell system according to Embodiment 2, the anode gas having been supplied from the fuel gas supplying device 101 through the fuel gas supplying passage 105 (fuel gas supplying pipe 32I) flows through the internal space of the container 62 constituting the CO remover 64. At this time, the CO contained in the anode gas and the air (oxygen) react with each other by the CO removing catalyst supported by the carrier 63, thereby removing the CO. Then, the anode gas flowing through the internal space of the container 62 turns at the other end portion of the container 62, flows through a space formed between the anode gas supplying manifold 221 and the container 62, and flows through the anode gas channel 7 formed on the anode separator 6a of each cell 11.

With this configuration, in the fuel cell system according to Embodiment 2, since the surface area for supporting the CO removing catalyst increases by disposing the CO remover 64, a larger amount of the CO removing catalyst can be supported, and thereby it is possible to surely remove the CO contained in the anode gas.

The other features of the configuration of the fuel cell system according to Embodiment 2 are the same as those of the configuration of the fuel cell system according to Embodiment 1, and explanations thereof are omitted.

Next, a modification example of the CO remover 64 of the fuel cell system according to Embodiment 2 will be explained below.

### Modification Example 1

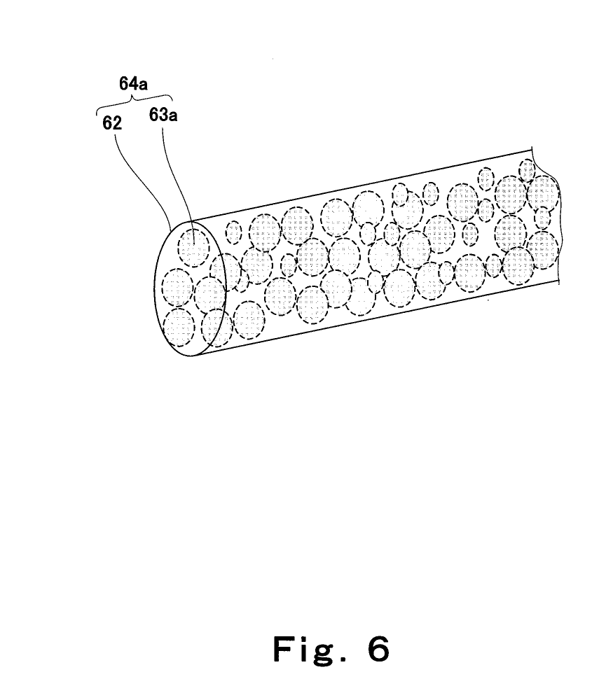

FIG. 6 is a schematic diagram showing the configuration of a CO remover 64a of Modification Example 1 of Embodiment 2.

As shown in FIG. 6, in Modification Example 1, pellet-form carriers 63a supporting the CO removing catalyst are filled in the internal space of the container 62 such that gaps remain in the internal space of the container 62. The carrier 64 has such a size that it does not flow into the anode gas channel 7, and its shape is not limited. Herein, the pellet-form carrier 63a is used, but the present modification example is not limited to this. For example, plate-like carriers may be stacked in the internal space of the container 62 such that gaps remain in the internal space of the container 62. Moreover, the pellet-form carrier 63a may be constituted by a porous body having a large number of fine holes, and the CO removing catalyst may be supported by an inner surface of the fine hole.

With this configuration, in the fuel cell system of the present modification example, while maintaining a larger capacity to support the CO removing catalyst, the anode gas can easily flow through the inside (to be specific, the internal space of the container 62) of the CO remover 64a.

From the foregoing explanation, many modifications and other embodiments of the present invention are obvious to one skilled in the art. Therefore, the foregoing explanation should be interpreted only as an example, and is provided for the purpose of teaching the best mode for carrying out the present invention to one skilled in the art. The structures and/or functional details may be substantially modified within the spirit of the present invention.

### Example

Hereinafter, Example of the present invention, i.e., one example of a method for manufacturing the fuel cell of the above embodiments will be explained.

### Example

In Example, the PEFC 100 explained in Embodiment 1 was manufactured through the following process.

First, formation of the MEA 5 will be explained.

Used as the polymer electrolyte membrane 1 was a 125 mm square membrane obtained by cutting a perfluoro carbon sulfonic acid membrane (Nafion 112 (trademark) produced by DUPONT).

A catalyst body (containing 50 wt % of Pt) was prepared by causing carbon powder, i.e., ketjen black (Ketjen Black EC produced by Ketjen Black International Company Ltd.; Particle diameter of 30 nm) to support platinum. 66 mass parts of the catalyst body was mixed with 34 mass parts (polymer dry mass) of a Nafion dispersion liquid (produced by Aldrich in U.S.) containing 5 mass % of perfluoro carbon sulfonic acid ionomer. Using this liquid mixture, the anode catalyst layer 2a and the cathode catalyst layer 2b each having a 120 mm square and a thickness of 10 to 20 μm were printed on both surfaces, respectively, of the polymer electrolyte membrane 1 by screen printing.

Next, the anode gas diffusion layer 3a and the cathode gas diffusion layer 3b were manufactured as follows.

Used as a base material was carbon woven fabric (for example, GF-20-E produced by Nippon Carbon Co., Ltd.), 80% or more of which was fine holes each having a diameter of 20 to 70 μm. PTFE dispersion liquid was prepared by dispersing polytetrafluoroethylene (PTFE) in a solution prepared by mixing pure water and a surfactant (for example, Triton X-51). The base material was immersed in this PTFE dispersion liquid, and the immersed base material was burned with a far infrared drying furnace at 300° C. for 60 minutes. Next, a solution was prepared again by mixing pure water and a surfactant (for example, Triton X-51). Carbon black was added to this liquid mixture and dispersed using a planetary mixer. Thus, carbon black dispersing liquid was prepared. PTFE and pure water were further added to this carbon black dispersing liquid, and this liquid was mixed for about three hours. Thus, a coating-layer paint was prepared. One main surface of the burned base material was coated with this coating-layer paint using a coating machine. The coated base material was burned with a hot air drier at 300° C. for two hours. The burned base material was cut to be a 120 mm square. Thus, the anode gas diffusion layer 3a and the cathode gas diffusion layer 3b were formed.

Next, the anode gas diffusion layer 3a, the cathode gas diffusion layer 3b and the polymer electrolyte membrane 1 were joined to one another by hot pressing such that the coating-layer formed surface of the anode gas diffusion layer 3a and the coating-layer formed surface of the cathode gas diffusion layer 3b contact the anode catalyst layer 2a and the cathode catalyst layer 2b, respectively, which were printed on the polymer electrolyte membrane 1. Thus, the MEA 5 was manufactured.

Alternatively, liquid mixture of the catalyst body and the Nafion dispersion liquid may be printed by screen printing on the coating-layer formed surfaces of the burned base materials, i.e., the anode gas diffusion layer 3a and the cathode gas diffusion layer 3b, thereby manufacturing the anode 4a and the cathode 4b. Then, the anode 4a, the cathode 4b, and the polymer electrolyte membrane 1 may be joined to one another by hot pressing, thereby manufacturing the MEA 5.

Next, a fluorocarbon rubber sheet was stamped out to manufacture gaskets 6 having a suitable shape. The gaskets 6 were disposed on an exposed peripheral portion of the polymer electrolyte membrane 1 which portion is located around the anode 4a, and on an exposed peripheral portion of the polymer electrolyte membrane 1 which portion is located around the cathode 4b. These were joined to one another by hot pressing.

Next, each of the anode separator 6a and the cathode separator 6b was manufactured by forming the anode gas channel 7 or the cathode gas channel 8, the heat transfer medium channel 9a or 9b, manifold holes, such as the anode gas supplying manifold hole 22I and the anode gas discharging manifold hole 22E, and the like, by machining on a graphite plate impregnated with phenol resin and having a thickness of 3 mm and a 150 mm square (see FIGS. 3 and 4). Each of the anode gas channel 7, the cathode gas channel 8, and the heat transfer medium channels 9a and 9b was formed to have a width of 1 mm, a depth of 1 mm, and a channel-to-channel distance of 1 mm.

Next, the CO removing catalyst layer 61 was formed on the anode gas internal supplying channel in the following manner.

First, the anode gas channel 7 and anode gas supplying manifold 12I of the anode separator 6a and the anode gas supplying manifold 121 of the cathode separator 6b were subjected to a treatment of improving hydrophilicity using plasma to increase a bond strength of the CO removing catalyst.

Next, a catalyst body (containing 30 wt % of Pt and 24 wt % of Ru) was prepared by causing carbon powder, i.e., ketjen black (Ketjen Black EC produced by Ketjen Black International Company Ltd.; Particle diameter of 30 nm) to support an alloy of Pt and Ru. 66 mass parts of the catalyst body was mixed with 34 mass parts (polymer dry mass) of a Nafion dispersion liquid (produced by Aldrich in U.S.) containing 5 mass % of perfluoro carbon sulfonic acid ionomer. This liquid mixture was printed on the inner wall of the groove-like anode gas channel 7 and the inner wall constituting the anode gas supplying manifold hole 12I by screen printing to form a layer having a thickness of 10 to 20 μm. The Nafion dispersion liquid may be replaced with resin, such as polyethylene, fluorocarbon resin or epoxy resin, or a dissolving agent in which a rubber material, such as SBR, is dissolved. Moreover, vacuum deposition or the like may be used as a method for forming the CO removing catalyst layer on the inner wall of the anode gas channel 7 of the separator and the inner wall constituting the anode gas supplying manifold 12I.

Then, the anode separator 6a and the cathode separator 6b sandwiched the MEA 5 and the gaskets 10 to manufacture the cell 11. The cells 11 were stacked to form the cell stack body 50, and were fastened by fastening members such that the load per area of the separator was 10 kgf/cm². Thus, the cell stack 51 was formed.

The PEFC of Example manufactured as above can remove the CO contained in the anode gas before the CO reaches the anode catalyst. Therefore, it is possible to surely avoid the deterioration of the cell performance due to the CO poisoning of the anode catalyst.

Next, a test for the CO removing ability of the CO remover 64a in Modification Example 1 of the fuel cell system according to Embodiment 2 will be explained.

### Test Example 1

In Test Example 1, the CO removing ability was examined as follows: 1 g of the CO remover 64a (to be specific, the carrier 63a to which a sintered body of silica (SiO₂) and alumina (Al₂O₃) supporting Ru, i.e., the CO removing catalyst, was applied) was put in a gas pipe (having a length of 4 cm and a diameter of 1.9 cm) used as the anode gas supplying manifold 22I; and the anode gas (Composition: 73% of H₂, 25.5% of CO₂, 1.5% of air, and 20 ppm of CO) of 80° C. was supplied at 150 ml/min.

As a result, the concentration of the CO in the anode gas was reduced from 20 ppm to 3 ppm. Thus, it was confirmed that the CO was adequately removed by disposing the CO remover 64a in the anode gas supplying manifold 22I.

The fuel cell system according to the above embodiments was explained as a domestic fuel cell system, but is not limited to this, and may be used as a fuel cell system of, for example, a motorcycle, an electric car, a hybrid electric car, a home electric appliance, and a mobile electric device, such as a mobile computer, a mobile phone, a mobile audio equipment, or a mobile information terminal.

### INDUSTRIAL APPLICABILITY

A polymer electrolyte fuel cell of the present invention and a fuel cell system including the same are useful as a fuel cell capable of removing the CO in a fuel gas before the CO reaches an anode catalyst, and a fuel cell system including such fuel cell.

1. A polymer electrolyte fuel cell comprising:
cells, each of which includes: an MEA having a polymer electrolyte membrane, and an anode and a cathode sandwiching the polymer electrolyte membrane; and an anode separator and a cathode separator disposed to sandwich the MEA; and
a cell stack formed by stacking the cells, wherein:
the anode separator is provided on an inner surface thereof with a groove-like anode gas channel and provided at a starting end of the anode gas channel with an anode gas supplying manifold hole, which penetrates through the anode separator in a stack direction and is used to supply the fuel gas and the air;
the anode gas supplying manifold holes are communicated with each other so as to form an anode gas supplying manifold, by stacking the cells; and
at least one of a CO removing catalyst layer containing a CO removing catalyst and a CO remover is disposed in the anode gas supplying manifold.

2. The polymer electrolyte fuel cell according to claim 1, wherein the CO removing catalyst layer further contains a carrier, which supports the CO removing catalyst.

3. The polymer electrolyte fuel cell according to claim 1, wherein the CO remover is disposed in the anode gas supplying manifold.

4. The polymer electrolyte fuel cell according to claim 1, wherein: the CO removing catalyst layer is disposed in the anode gas supplying manifold.

5. (canceled)

6. The polymer electrolyte fuel cell according to claim 4, wherein the CO removing catalyst layer is further disposed in the anode gas channel.

7. The polymer electrolyte fuel cell according to claim 1, wherein:
the CO remover contains the CO removing catalyst, a carrier supporting the CO removing catalyst, and a container having non-electrical conductivity and gas permeability; and
the carrier is stored in the container.

8. The polymer electrolyte fuel cell according to claim 7, wherein the carrier is stored in the container such that an inside of the container has gas permeability.

9. The polymer electrolyte fuel cell according to claim 8, wherein the carrier is formed of a porous body.

10. The polymer electrolyte fuel cell according to claim 8, wherein the carrier is in a pellet form.

11. The polymer electrolyte fuel cell according to claim 1, wherein the CO removing catalyst contains as a constituent element at least one metallic element selected from a metal group consisting of Pt, Ru, Pd, Au, and Rh.

12. The polymer electrolyte fuel cell according to claim 2, wherein the CO removing catalyst layer is formed such that the carrier supports simple substances of at least two metals and/or metal oxides selected from the metal group forming the CO removing catalyst and a metal oxide group consisting of oxides of metals of the metal group, and the simple substances contact each other.

13. A fuel cell system comprising:
the polymer electrolyte fuel cell according to claim 1;
a fuel gas supplying device which supplies the fuel gas to the anode;
an air supplying device which supplies the air to the anode gas internal supplying channel; and
an oxidizing gas supplying device which supplies the oxidizing gas to the cathode.
